(19) United States
(12) Patent Application Publication
(10) Pub. No.: US 2020/0145342 A1
(43) Pub. Date: May 7, 2020

(54) METHOD AND SYSTEM FOR OPTIMIZING DATA FLOW BETWEEN DEVICES

(71) Applicant: Danfoss Power Solutions, Inc., Ames, IA (US)

(72) Inventors: Henrik Olesen, Egernsund (DK); Fredrik Bjoern, Vaxjo (SE)

(21) Appl. No.: 16/180,192

(22) Filed: Nov. 5, 2018

(51) Int. Cl. H04L 12/805; H04L 29/06

(52) U.S. Cl. CPC H04L 47/365; H04L 12/66; H04L 65/80; H04L 65/104

(57) ABSTRACT

A system and method for transmitting data between a first device on a first network and a second device on a second network includes positioning a gateway intermediate the first network and second network, where the gateway intercepts data transmissions sent from the first device to the second device in a first packet size, converts the data transmissions from the first packet size to a second packet size, and delivers the data transmissions to the second device in the second packet size.

### TECHNICAL FIELD

The present invention relates to data communication and, more particularly, to methods and systems for controlling data flow in communications between devices.

### BACKGROUND

In data communication networks, a quantum of data is transferred between physical devices by breaking the quantum of data into a plurality of addressed data packets (i.e. smaller units of data) that are then transmitted and routed over the communication network from the a sending device to a receiving device, where they are received and reassembled.

When two physical devices with different latency characteristics are logically connected for data transfer, the quantum of data must be divided into packets that do not exceed the maximum packet size of either connected device. This means that the least capable device determines the size of the packets during the data transfer. Additionally, in order to send each new data packet, the sending device must first await an acknowledgement from the receiving device of receipt of the previous packet before it is allowed to send the new packet. As a result of these factors, the throughput of the data transfer suffers and, on a high latency link, the time between transmissions of two consecutive packets can be considerable. Thus, the data transfer is inefficient.

### SUMMARY

According to the present disclosure, a system for transmitting data between a first device and a second device that overcomes the inefficiencies described above is disclosed. The system comprises a first network having a first latency characteristic defining a first packet size for data transmission over the first network, wherein the first device is operating on the first network, and a second network having a second latency characteristic defining a second packet size for data transmission over the second network, wherein the second device is operating on the second network. The system further comprises a gateway intermediate the first network and second network. The gateway is configured to intercept data transmissions sent from the first device to the second device in the first packet size, to convert the data transmissions from the first packet size to the second packet size, and to deliver the data transmissions to the second device in the second packet size.

According to the present disclosure, the gateway may be further configured to intercept data transmissions sent from the second device to the first device in the second packet size, to convert the data transmissions from the second packet size to the first packet size, and to deliver the data transmissions to the first device in the first packet size.

According to the present disclosure, the first packet size and second packet size may be different. The first packet size may be smaller or larger than the second packet size.

According to the present disclosure, a method for transmitting data between a first device operating on a first network and a second device operating on a second network is disclosed. The method comprises intercepting, at a gateway intermediate the first network and the second network, a data transmission sent from the first device to the second device in a first packet size. The method further comprises converting the data transmission from the first packet size to a second packet size at the gateway, and delivering, from the gateway, the converted data transmission to the second device in the second packet size.

According to the present disclosure, the method may include converting data transmissions wherein the first packet size and second packet size are different. The first packet size may be smaller or larger than the second packet size.

According to the present disclosure, converting the data transmission from the first packet size to the second packet size may comprise splitting each packet of the first packet size into multiple packets of the second packet size.

According to the present disclosure, converting the data transmission from the first packet size to the second packet size may comprise combining multiple packets of the first packet size into a singe packet of the second packet size.

According to the present disclosure, the method for transmitting data between the first device operating on the first network and the second device operating on the second network, may further comprise receiving, at the gateway, a request from the first device for a maximum packet size available to the second device, forwarding, from the gateway to the second device, the request for the maximum packet size available to the second device, receiving, at the gateway, a response from the second device indicating that the maximum packet size available to the second device is the second packet size, and sending, from the gateway to the first device, a response indicating that the maximum packet size available to the second device is the first packet size rather than the second packet size.

According to the present disclosure, delivering the converted data transmissions to the second device in the second packet size from the gateway may comprise sending a first portion of the data transmission to the second device as a first packet of the second packet size, receiving, at the gateway, confirmation that the first packet has been received by the second device, and repeating the sending and receiving steps with subsequent portions of the data transmission until the entire data transmission has been received by the second device.

According to the present disclosure, the method may further comprise transmitting, from the gateway to the first device, an indication that the data transmission is complete after the entire data transmission has been received by the second device.

According to the present disclosure, a computer program product residing on a computer readable medium may have a plurality of instructions stored thereon which, when executed by a processor of a gateway operatively connecting a first network and a second network, may cause the processor to perform operations comprising intercepting, at the gateway, a data transmission sent in a first packet size from a first device on the first network to a second device on the second network, converting, at the gateway, the data transmission from the first packet size to a second packet size, and delivering, from the gateway, the converted data transmission to the second device in the second packet size.

According to the present disclosure, the computer program product may include instructions for converting data transmissions wherein the first packet size and second packet size are different. The first packet size may be smaller or larger than the second packet size.

According to the present disclosure, the computer program product may further comprise instructions for converting the data transmission from the first packet size to the second packet size by splitting each packet of the first packet size into multiple packets of the second packet size.

According to the present disclosure, the computer program product may further comprise instructions for converting the data transmission from the first packet size to the second packet size by combining multiple packets of the first packet size into a singe packet of the second packet size.

According to the present disclosure, the computer program product may further comprise instructions for: receiving, at the gateway, a request from the first device for a maximum packet size available to the second device, forwarding, from the gateway to the second device, the request for the maximum packet size available to the second device, receiving, at the gateway, a response from the second device indicating that the maximum packet size available to the second device is the second packet size, and sending, from the gateway to the first device, a response indicating that the maximum packet size available to the second device is the first packet size.

According to the present disclosure, the instructions for delivering the converted data transmissions to the second device in the second packet size from the gateway may further comprise instructions for sending, from the gateway, a first portion of the data transmission to the second device as a first packet of the second packet size, receiving, at the gateway, confirmation that the first packet has been received by the second device, and repeating the sending and receiving steps with subsequent portions of the data transmission until the entire data transmission has been received by the second device.

According to the present disclosure, the computer program product may further comprise instructions for transmitting, from the gateway to the first device, an indication that the data transmission is complete after the entire data transmission has been received by the second device.

These and other objects, features and advantages of the present disclosure will become apparent in light of the detailed description of embodiments thereof, as illustrated in the accompanying drawings.

### BRIEF DESCRIPTION OF THE DRAWINGS

FIG. 1 is a schematic diagram of a system for optimizing data transfer according to the present disclosure; and

FIG. 2 is a flowchart showing a method for providing improved data throughput between connected devices in the system of FIG. 1.

### DETAILED DESCRIPTION

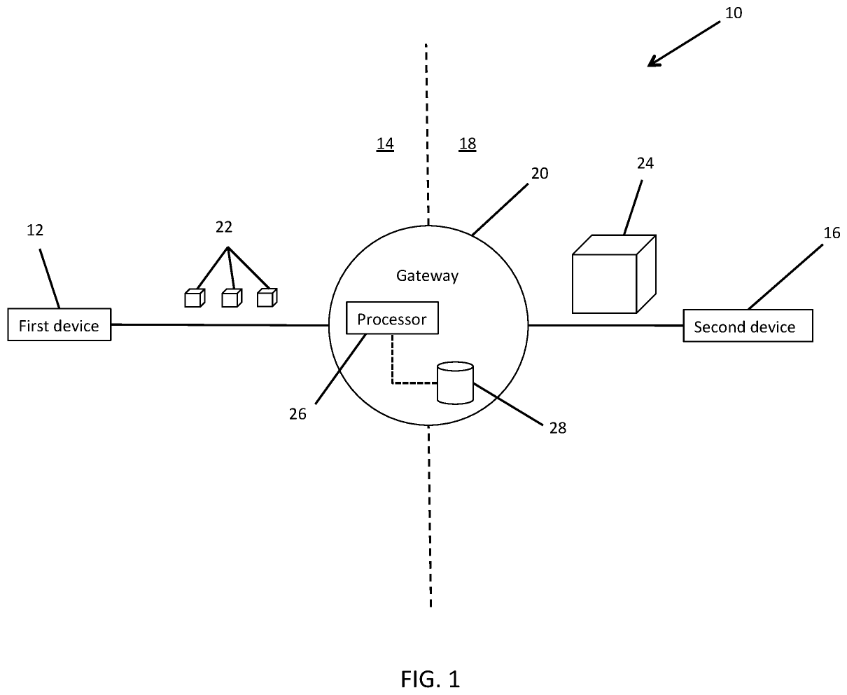

With reference to FIG. 1, a system 10 according to the present disclosure is shown. The system 10 includes a first device 12 operating on a first network 14, a second device 16 operating on a second network 18, and a gateway 20 connecting the first network 14 and the second network 18. Each of the first network 14 and the second network 18 is optimized for either low latency and low memory usage or high latency and higher memory usage. Data transfer over any network is typically optimized for either low latency and low memory usage or high latency and higher memory usage depending at least in part on memory capabilities of the physical devices on the network. The physical devices may be, for example, electronic control units (ECUs) and various devices associated therewith, such as controllers, displays, valves, and/or other similar controlling or controlled components.

For exemplary purposes, the present disclosure describes the first network 14 as a low latency network and describes the second network 18 as a high latency network. For example, the first network 14 may be a vehicle control system that transfers data over short geographical distances and includes network components having low memory usage capabilities. The vehicle control system may include, for example, propulsion controllers, braking controllers, safety systems, and various other systems and subsystems operatively connected to one another over a Controller Area Network (CAN or CAN bus) or other similar network that allows the various control systems, controllers, subsystems, and the like to communicate with one another using CAN or other communication protocols known in the art. The second network 18 may a network that transfers data over long geographical distances, such as the Internet, and relies on network components having high memory usage capabilities. Since the first network 14 is optimized for low latency, the first network 14 is configured to transfer data using small data packets 22 so as not to exceed the low memory capabilities of the system components. Conversely since the second network 18 is optimized for high latency, the second network 18 is configured to transfer data using large data packets 24, which can be supported by the high memory capabilities of the system components.

Although the present disclosure describes the first network 14 as a low latency network and the second network 18 as a high latency network, it should be readily apparent that the first network 14 may instead be a high latency network and/or the second network 18 may instead be a low latency network.

The gateway 20 serves as an interface between the first network 14 and the second network 18 to transfer data therebetween. For example, the gateway 20 may form part of the first network 14 and may be operatively connectable to the second network 18 through, for example, a wired or wireless communication connection or the like, to allow data transfer between the first network 14 and the second network 18. Similarly, the gateway 20 may form part of the second network 18 and may be operatively connectable to the first network 14 through, for example, a wired or wireless communication connection or the like, to allow data transfer between the first network 14 and the second network 18. Alternatively, the gateway 20 may be a standalone component operatively connectable to both the first network 14 and second network 18 through a wired or wireless communication connection or the like, to allow data transfer between the first network 14 and the second network 18. The gateway 20 masquerades the data transfer capabilities of the first network 14 and second network 18 when data is being transferred between the first device 12 operating on the first network 14 and the second device 16 operating on the second network 18 to improve data throughput between the devices as described below. For instance, some devices such as some valves may only support a packet size up to 50 bytes, while some controllers and/or displays may support packet sizes over 1000 bytes. The gateway 20 masquerades the data transfer capabilities of all of these devices by responding to transfer capability requests with an artificially high value such as 65000 bytes or more.

The gateway 20 includes all of the necessary electronics, software, memory, storage, databases, firmware, logic/state machines, microprocessors, communication links, and any other input/output interfaces to perform the functions described herein and/or to achieve the results described herein. For example, the gateway 20 may include, or be in communication with, one or more processors 26 and memory 28, which may include system memory, including random access memory (RAM) and read-only memory (ROM). Suitable computer program code may be provided to the gateway 20 for executing numerous functions, including those discussed herein in connection with improving data throughput between the first device 12 operating on the first network 14 and the second device 16 operating on the second network 18.

The one or more processors 26 may include one or more conventional microprocessors and may also include one or more supplementary co-processors such as math co-processors or the like. The one or more processors 26 may be configured to communicate with other networks, such as the first network 14 and second network 18, and/or devices, such as the first device 16 and second device 18, as well as various other servers, processors, computers, smartphones, tablets and/or the like.

The one or more processors 26 may be in communication with the memory 28, which may comprise magnetic, optical and/or semiconductor memory, such as, for example, random access memory (“RAM”), read only memory (“ROM”), flash memory, optical memory, or a hard disk drive memory. Memory 28 may store any data and/or information typically found in computing devices, including an operating system, and/or one or more other programs (e.g., computer program code and/or a computer program product) that are stored in a non-transitory memory portion and adapted to direct the gateway 20 and system 10 to perform according to the various embodiments discussed herein. The gateway 20 and control logic and/or portions thereof, and/or any other programs may be stored, for example, in a compressed format, an uncompiled and/or an encrypted format, and may include computer program code executable by the one or more processors 26. The executable instructions of the computer program code may be read into a main memory of the one or more processors 26 from a non-transitory computer-readable medium other than the memory 28. While execution of sequences of instructions in the program causes the one or more processors 26 to perform the process steps described herein, hard-wired circuitry may be used in place of, or in combination with, executable software instructions for implementation of the processes of the present invention. Thus, embodiments of the present invention are not limited to any specific combination of hardware and software.

For example, the methods and systems discussed herein and portions thereof may also be implemented in programmable hardware devices such as field programmable gate arrays, programmable array logic, programmable logic devices or the like. Programs may also be implemented in software for execution by various types of computer processors. A program of executable code may, for instance, comprise one or more physical or logical blocks of computer instructions, which may, for instance, be organized as an object, procedure, process or function. Nevertheless, the executables of an identified program need not be physically located together, but may comprise separate instructions stored in different locations which, when joined logically together, comprise the program and achieve the stated purpose for the programs such as providing workflow analysis. In an embodiment, an application of executable code may be a compilation of many instructions, which may be distributed over several different code partitions or segments, among different programs, and across several devices.

The term “computer-readable medium” as used herein refers to any medium that provides or participates in providing instructions and/or data to the one or more processors of the system 10, including the gateway 20, (or any other processor of a device described herein) for execution. Such a medium may take many forms, including but not limited to, non-volatile media or memory and volatile memory. Non-volatile memory may include, for example, optical, magnetic, or opto-magnetic disks, or other non-transitory memory. Volatile memory may include dynamic random access memory (DRAM), which typically constitutes the main memory or other transitory memory.

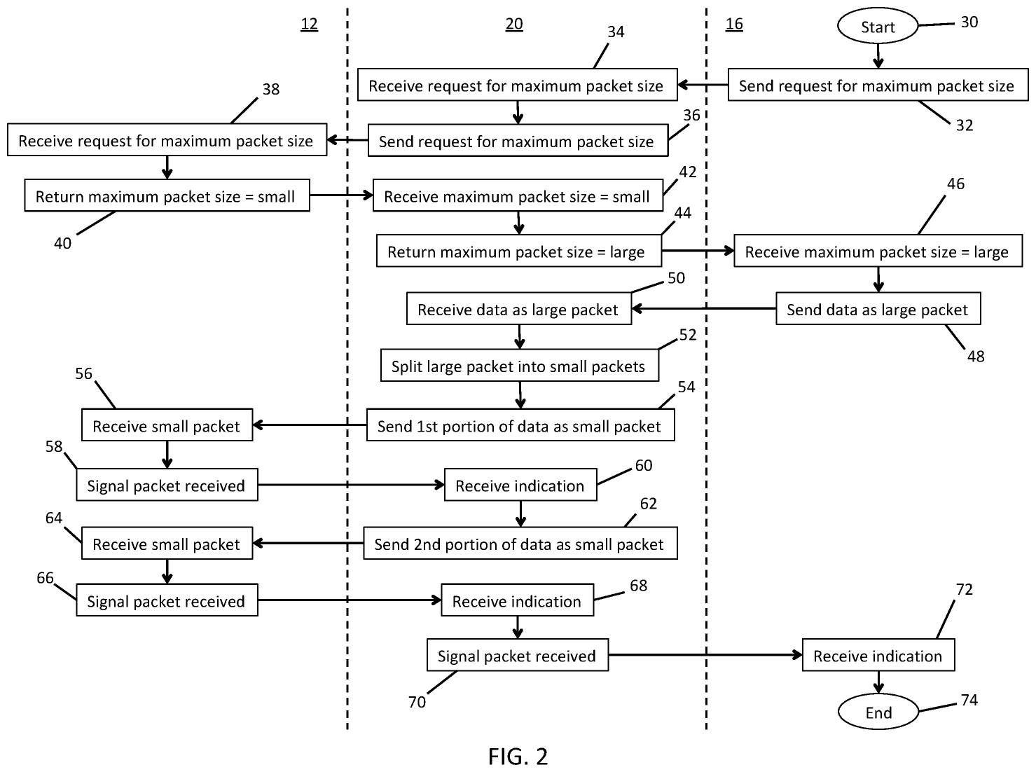

Referring to FIG. 2, a method and system for data transfer between the first device 12 and second device 16 through the gateway 20 according to the present disclosure is shown. The first device 12 and second device 16 are operatively connected to one another through the gateway 20, but neither the first device 12 nor the second device 16 is aware that the gateway 20 is between the two devices. In the example shown, a quantum of data is being transferred from the second device 16, which supports large packet sizes, to the first device 12, which only supports small packet sizes. However, it should be readily apparent that the same method and system is applicable to data transfers from the first device 12 to the second device 16.

The data transfer from the second device 16 to the first device 12 is initiated at step 30. At step 32, the second device 16 sends a request to the first device 12 asking for the maximum packet size supported by the first device 12. This request is intercepted by the gateway 20 at step 34. At step 36, the gateway 20 forwards the request to the first device 12 without modification. At step 38, the first device 12 receives the request asking for the maximum packet size supported by the first device. At step 40, the first device 12 responds with the maximum packet size that it supports, which is illustrated as a “small” packet size in the exemplary embodiment of FIG. 2. This response is intercepted by the gateway 20 at step 42. At step 44, the gateway 20 replaces the maximum packet size returned by the first device 12 with a larger value of maximum packet size, such as the size supported by the second device 16, and returns the larger packet size to the second device 16. The packet size returned from the gateway 20 to the second device 16 is illustrated as “large” in the example shown in FIG. 2. The second device 16 receives this indication of packet size from the gateway 20 at step 46.

At step 48, the second device 16 then transmits the quantum of data to the first device 12. Due to the modification of the maximum packet size information by the gateway 20 at step 44, the second device 16 uses a packet size the exceeds the capabilities of the first device 12 when sending the quantum of data at step 48. At step 50, the gateway 20 intercepts the packet of data being sent from the second device 16 to the first device 12. The gateway 20 knows the actual maximum packet size of the first device 12 since the gateway 20 received the actual maximum packet size of the first device 12 at step 42. Thus, using the actual maximum packet size of the first device 12, at step 52, the gateway 20 splits the large packet of data received from the second device 16 into multiple smaller packets. The actual number of smaller packets that the gateway 20 splits the large packet into depends on a ratio between the size of the actual maximum packet size of first device 12 and the actual packet size of the large packet sent by the second device 16. For exemplary purposes, FIG. 2 illustrates the large packet of data sent by the second device 16 being split into two smaller packets of data by the gateway 20. At step 54, the gateway 20 transmits a first portion of the large packet of data received from the second device 16 to the first device 12 as a first small packet. At step 56, the first device 12 receives the first small packet from the gateway 20 and, at step 58, the first device 12 sends a signal indicating that the first small packet has been received. At step 60, the gateway 20 intercepts the indication from the first device 12 confirming receipt of the first small packet. At step 62, the gateway 20 then transmits a second portion of the large packet of data received from the second device 16 to the first device 12 as a second small packet. At step 64, the first device 12 receives the second small packet from the gateway 20 and, at step 66, the first device 12 sends a signal indicating that the second small packet has been received. At step 68, the gateway 20 intercepts the indication from the first device 12 confirming receipt of the second small packet. Then, at step 70, the gateway sends a signal to the second device 16 indicating that the transfer of the large packet of data that the second device 16 initiated has been completed. The second device 16 receives this indication at step 72. Then, if additional large packets of data are necessary to for transmission of the quantum of data, the second device 16 transmits another large packet of data to the first device 12 through the gateway 20 in the same manner described in connection with steps 48 though 72. Alternatively, the second device 16 ends the transfer at step 74.

Although the exemplary implementation of the system and method of the present disclosure shown in FIG. 2 describes the gateway 20 splitting a large data packet received from the second device 16 over the high latency link into multiple small packets sent to the first device 12 over the low latency link, it should be readily apparent from the present disclosure that the gateway 20 may instead receive multiple small packets from a transmitting device over the low latency link and may combine the multiple small packets into one or more large packets for transmission to a receiving device over the high latency link.

The system and method of the present disclosure advantageously improves data throughput by positioning the gateway 20 intermediate the first device 12 and second device 16 to masquerading the capability of the end device receiving the data, which is the first device 12 in the illustrative example described above. In doing so, the system and method of the present disclosure reduces the number of packets transmitted from the second device 16 over the high latency second network 18, while still allowing data packets of the appropriate smaller size to be transmitted to the first device 12 over the low latency first network 14. Thus, data throughput between the first and second devices is advantageously improved.

While various embodiments have been described in the present disclosure, it will be appreciated by those of ordinary skill in the art that modifications can be made to the various embodiments without departing from the spirit and scope of the invention as a whole. Accordingly, the particular embodiments described in this specification are to be taken as merely illustrative and not limiting.

What is claimed is:

1. A system for transmitting data between a first device and a second device, the system comprising:
a first network having a first latency characteristic defining a first packet size for data transmission over the first network, the first device operating on the first network;
a second network having a second latency characteristic defining a second packet size for data transmission over the second network, the second device operating on the second network; and
a gateway intermediate the first network and second network;
wherein the gateway is configured to intercept data transmissions sent from the first device to the second device in the first packet size, to convert the data transmissions from the first packet size to the second packet size, and to deliver the data transmissions to the second device in the second packet size.

2. The system according to claim 1, the gateway is further configured to intercept data transmissions sent from the second device to the first device in the second packet size, to convert the data transmissions from the second packet size to the first packet size, and to deliver the data transmissions to the first device in the first packet size.

3. The system according to claim 1, wherein the first packet size and second packet size are different.

4. The system according to claim 3, wherein the first packet size is smaller than the second packet size.

5. A method for transmitting data between a first device operating on a first network and a second device operating on a second network, the method comprising:
intercepting, at a gateway intermediate the first network and the second network, a data transmission sent from the first device to the second device in a first packet size;
converting the data transmission from the first packet size to a second packet size at the gateway; and
delivering, from the gateway, the converted data transmission to the second device in the second packet size.

6. The method according to claim 5, wherein the first packet size and second packet size are different.

7. The method according to claim 6, wherein the first packet size is larger than the second packet size.

8. The method according to claim 5, wherein converting the data transmission from the first packet size to the second packet size comprises splitting each packet of the first packet size into multiple packets of the second packet size.

9. The method according to claim 5, wherein converting the data transmission from the first packet size to the second packet size comprises combining multiple packets of the first packet size into a singe packet of the second packet size.

10. The method according to claim 5, further comprising:
receiving, at the gateway, a request from the first device for a maximum packet size available to the second device;
forwarding, from the gateway to the second device, the request for the maximum packet size available to the second device;
receiving, at the gateway, a response from the second device indicating that the maximum packet size available to the second device is the second packet size; and
sending, from the gateway to the first device, a response indicating that the maximum packet size available to the second device is the first packet size.

11. The method according to claim 5, wherein delivering the converted data transmissions to the second device in the second packet size from the gateway comprises:
sending, from the gateway, a first portion of the data transmission to the second device as a first packet of the second packet size;
receiving, at the gateway, confirmation that the first packet has been received by the second device; and
repeating the sending and receiving steps with subsequent portions of the data transmission until the entire data transmission has been received by the second device.

12. The method according to claim 11, further comprising:
transmitting, from the gateway to the first device, an indication that the data transmission is complete after the entire data transmission has been received by the second device.

13. A computer program product residing on a computer readable medium having a plurality of instructions stored thereon which, when executed by a processor of a gateway operatively connecting a first network and a second network, cause the processor to perform operations comprising:
intercepting, at the gateway, a data transmission sent in a first packet size from a first device on the first network to a second device on the second network;
converting, at the gateway, the data transmission from the first packet size to a second packet size; and
delivering, from the gateway, the converted data transmission to the second device in the second packet size.

14. The computer program product according to claim 13, wherein the first packet size and second packet size are different.

15. The computer program product according to claim 14, wherein the first packet size is larger than the second packet size.

16. The computer program product according to claim 13, further comprising instructions for converting the data transmission from the first packet size to the second packet size by splitting each packet of the first packet size into multiple packets of the second packet size.

17. The computer program product according to claim 13, further comprising instructions for converting the data transmission from the first packet size to the second packet size by combining multiple packets of the first packet size into a singe packet of the second packet size.

18. The computer program product according to claim 13, further comprising instructions for:
receiving, at the gateway, a request from the first device for a maximum packet size available to the second device;
forwarding, from the gateway to the second device, the request for the maximum packet size available to the second device;
receiving, at the gateway, a response from the second device indicating that the maximum packet size available to the second device is the second packet size; and
sending, from the gateway to the first device, a response indicating that the maximum packet size available to the second device is the first packet size.

19. The computer program product according to claim 13, wherein the instructions for delivering the converted data transmissions to the second device in the second packet size from the gateway further comprise instructions for:
sending, from the gateway, a first portion of the data transmission to the second device as a first packet of the second packet size;
receiving, at the gateway, confirmation that the first packet has been received by the second device; and
repeating the sending and receiving steps with subsequent portions of the data transmission until the entire data transmission has been received by the second device.

20. The computer program product according to claim 19, further comprising instructions for:
transmitting, from the gateway to the first device, an indication that the data transmission is complete after the entire data transmission has been received by the second device.
